(19) United States
(12) Patent Application Publication
(10) Pub. No.: US 2017/0187077 A1
(43) Pub. Date: Jun. 29, 2017

(54) BATTERY SYSTEM OF AN ELECTRIC VEHICLE

(71) Applicant: Proterra Inc., Greenville, SC (US)

(72) Inventors: Timothy J. McCARTNEY, Greer, SC (US); Michael C. WALKER, Daly City, CA (US)

(73) Assignee: Proterra Inc., Greenville, SC (US)

(21) Appl. No.: 14/980,816

(22) Filed: Dec. 28, 2015

(51) Int. Cl. H01M 10/42; H01M 2/10; H01M 2/34; H01M 2/26; H01M 4/485

(52) U.S. Cl. CPC H01M 10/4257; H01M 2/26; H01M 4/485; H01M 2/34; H01M 2/1077; H01M 2220/20; H01M 2010/4271

(57) ABSTRACT

A battery system for an electric vehicle includes a container having a lid and a plurality of battery cells housed in the container. Each battery cell of the plurality of battery cells may include a pair of tabs to electrically connect to the battery cell, a printed circuit board housed in the container, and a pair of contact elements. The printed circuit board may include circuitry adapted to monitor at least one battery cell. And, each contact element may be attached to the printed circuit board and configured to separably contact a tab of the at least one battery cell to electrically connect the at least one battery cell to the printed circuit board.

### TECHNICAL FIELD

Embodiments of this disclosure relate to electric vehicle battery systems.

### BACKGROUND

An electric vehicle (EV) uses an electric motor for propulsion. Electric vehicles may include all-electric vehicles where the electric motor is the sole source of power, and hybrid electric vehicles that include an auxiliary power source in addition to the electric motor. Energy to power the motor is stored in a battery system located in the vehicle. Typically, the battery system includes multiple batteries connected together. Each battery may include a plurality of battery cells connected together. When the stored energy in the battery system decreases, it is charged by connecting the vehicle to an external or auxiliary power supply. During charging, electric current is directed into the battery cells and during discharging, electric current is drawn from the battery cells.

To ensure that all the battery cells of the battery system are operating properly, the electrical parameters (e.g., voltage, current, etc.) and operating conditions (e.g., temperature, humidity, etc.) (collectively referred to as “operating parameters”) of these cells may be continuously monitored using a control system. Electrical wires or leads are connected between these cells and circuits of the control system to measure the operating parameters. Typically these leads are connected to the cells by attachment processes such as soldering, welding, riveting, etc. Electric vehicle battery systems may include thousands of individual battery cells. Soldering/welding/riveting leads to each battery cell is a time consuming process which increases the cost of the battery system. These soldered leads may also be susceptible to failure. Identifying and repairing a defective lead may also be time consuming. The current disclosure may overcome some of the deficiencies discussed above.

### SUMMARY

Embodiments of the present disclosure relate to, among others, battery systems. Each of the embodiments disclosed herein may include one or more of the features described in connection with any of the other disclosed embodiments.

In one embodiment, a battery system for an electric vehicle is disclosed. The battery system may include a container having a lid and a plurality of battery cells housed in the container. Each battery cell of the plurality of battery cells may include a pair of tabs to electrically connect to the battery cell. The battery system may also include a printed circuit board housed in the container. The printed circuit board may include circuitry adapted to monitor at least one battery cell of the plurality of battery cells. The battery system may also include a pair of contact elements. Each contact element of the pair of contact elements may be attached to the printed circuit board and configured to separably contact a tab of the pair of tabs of at least one battery cell to electrically connect that battery cell to the printed circuit board.

In another embodiment, a battery system for an electric vehicle is disclosed. The battery system may include a plurality of battery packs electrically coupled together. Each battery pack of the plurality of battery packs may include a housing and a plurality of battery modules enclosed within the housing of each battery pack. Each battery module of the plurality of battery modules may include a container with a lid enclosing a plurality of battery cells therein. Each battery cell of the plurality of battery cells may include a pair of tabs to electrically connect to the battery cell. Each battery module may also include a printed circuit board attached to an inside surface of the lid. The printed circuit board may include circuitry adapted to monitor at least one battery cell of the plurality of battery cells. Each battery module may also include a pair of contact elements attached to the printed circuit board. Each contact element of the pair of contact elements may be configured to (a) make electrical contact with a tab of the pair of tabs of the at least one battery cell when the lid is closed, and (b) break electrical contact with the tab when the lid is opened.

In yet another embodiment, a method of controlling a battery system of an electric vehicle is disclosed. The battery system may include a container with a lid enclosing a plurality of battery cells therein and a control unit attached to an inside surface of the lid. The control unit may include a plurality of contact elements attached thereto. The method may include making electrical contact between the control unit and a battery cell of the plurality of battery cells through a pair of contact elements of the plurality of contact elements by closing the lid of the container. The method may also include breaking electrical contact between the control unit and the battery cell of the plurality of battery cells by opening the lid of the container.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1A and 1B illustrate different views of an exemplary electric bus having a battery system;

FIG. 2 illustrates an exemplary configuration of the battery system of the bus of FIG. 1A;

FIG. 3 illustrates an inside view of an exemplary battery pack of the battery system of FIG. 2;

FIG. 4 illustrates an inside view of an exemplary battery module of the battery system of FIG. 2;

FIG. 5 illustrates an exemplary electrical contact element used in the battery module of FIG. 4; and

FIGS. 6A-6E illustrate exemplary electrical contact elements that may be used in the battery module of FIG. 4.

### DETAILED DESCRIPTION

The present disclosure describes battery systems. While principles of the current disclosure are described with reference to a battery system of an electric bus, it should be understood that the disclosure is not limited thereto. Rather, the embodiments of the present disclosure may be used in any battery system (of an electric vehicle, machine, tool, appliance, etc.).

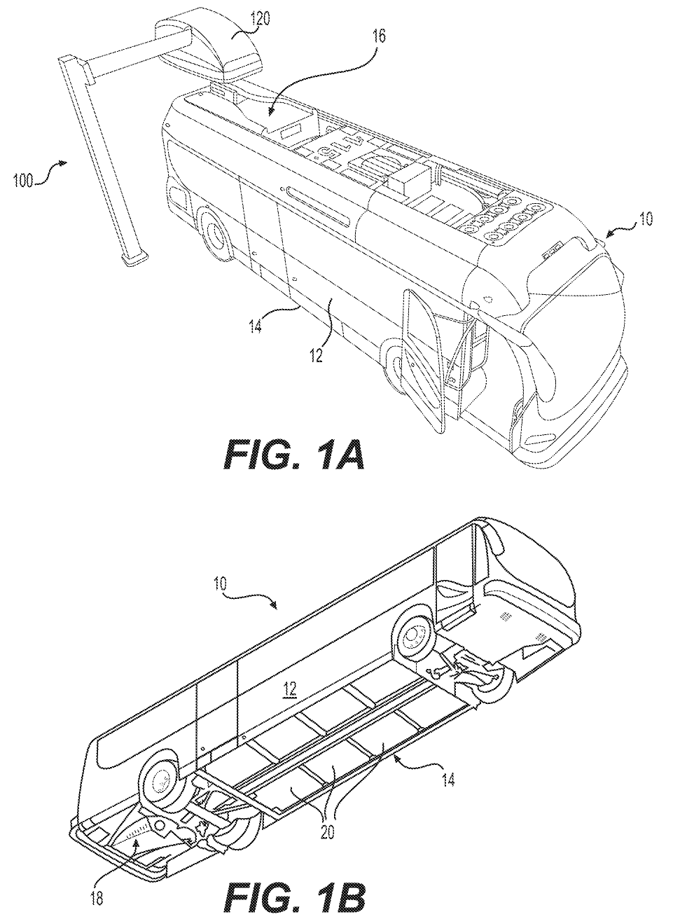

FIGS. 1A and 1B illustrate an electric vehicle in the form of an electric bus 10. FIG. 1A shows the top view of the bus 10 and FIG. 1B shows the undercarriage of the bus 10. In the discussion that follows, reference will be made to both FIGS. 1A and 1B. Bus 10 may include a body 12 enclosing a space for passengers. In some embodiments, some (or all) parts of body 12 may be fabricated using one or more composite materials to reduce the weight of the bus 10. In some embodiments, bus 10 may be a low-floor electric bus. As is known in the art, in a low-floor bus, there are no stairs at the front and/or the back doors of the bus. In such a bus, the floor is positioned close to the road surface to ease entry and exit into the bus. In some embodiments, the floor height of the low-floor bus may be about 12-16 inches (30-40 centimeters) from the road surface. Body 12 of bus 10 may have any size, shape, and configuration.

Bus 10 may include an electric motor 18 that generates power for propulsion. Batteries of a battery system 14 may store electrical energy to power the electric motor and other accessories (HVAC, lights, etc.). In some embodiments, as illustrated in FIG. 1B, the battery system 14 may be positioned under the floor of the bus 10. The battery system 14 may have a modular structure and may be configured as a plurality of battery packs 20. In some embodiments, each battery pack 20 may include a housing enclosing, among others, a plurality of battery modules, each having multiple battery cells. In some embodiments, as illustrated in FIG. 1B, the battery packs 20 may be arranged in two parallel columns under the floor.

Although the battery system 14 is illustrated and described as being positioned under the floor of the bus 10, this is only exemplary. In some embodiments, some or all of the battery packs 20 of the battery system 14 may be positioned elsewhere (e.g., roof, inside, etc.) on the bus 10. However, since the battery system 14 may be heavy, positioning the battery system 14 under the floor may lower the center of gravity of the bus 10 and balance weight distribution, thus increasing drivability and safety.

The batteries of battery system 14 may have any chemistry and construction. In some embodiments, the batteries may be lithium titanate oxide (LTO) batteries. In some embodiments, the batteries may be nickel manganese cobalt (NMC) batteries. LTO batteries may be fast charge batteries that may allow the bus 10 be recharged to substantially its full capacity in a small amount of time (e.g., about ten minutes or less). In this disclosure, the terms “about,” “substantially,” or “approximate” are used to indicate a potential variation of 10% of a stated value. Due to its higher charge density, NMC batteries may take longer to charge to a comparable state of charge (SOC), but NMC batteries may retain a larger amount of charge and thus increase the range of the bus 10. It is also contemplated that, in some embodiments, the batteries may include other or multiple different chemistries. For instance, some of the batteries may be LTO or NMC batteries, while other batteries may have another chemistry (for example, lead-acid, nickel cadmium, nickel metal hydride, lithium ion, zinc air, etc.). Some of the possible battery chemistries and arrangements in bus 10 are described in commonly assigned U.S. Pat. 8,453,773, which is incorporated herein by reference in its entirety.

A charging interface 16 may be provided on the roof of the bus 10 to charge the batteries of the battery system 14. The charging interface 16 may engage with the charging head 120 of an external charging station 100 to charge the batteries of the battery system 14. During charging, when the bus 10 is positioned under the overhanging charging head 120, the charging head 120 may descend to land on and engage with the charging interface 16. Details of the charging head 120 and the interfacing of the charging head 120 with the charging interface 16 of the bus 10 are described in commonly assigned U.S. Patent Application Publication Nos. US 2013/0193918 A1 and US 2014/0070767 A1, which are incorporated by reference in their entirety herein.

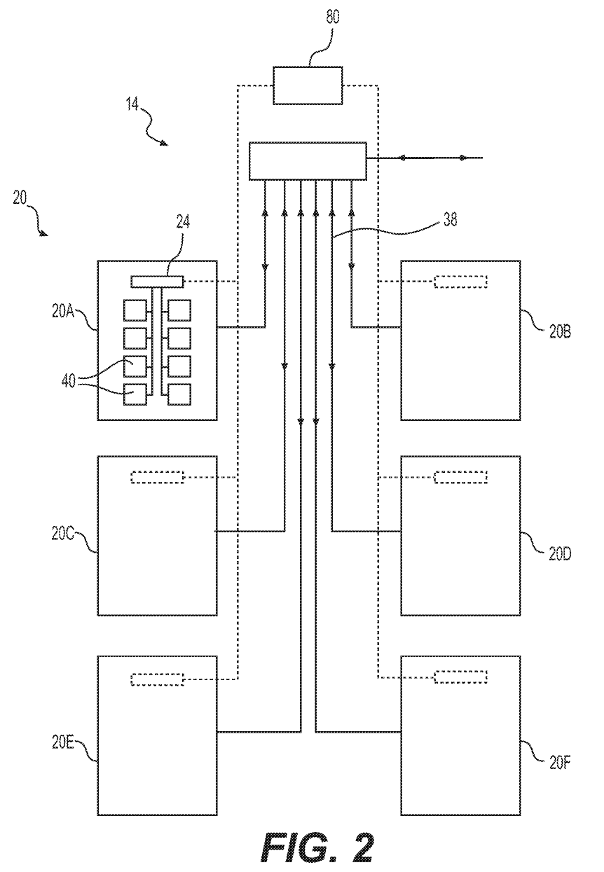

FIG. 2 illustrates an exemplary configuration of the battery system 14 of bus 10. In general, battery system 14 may include a plurality of battery packs 20 connected together in series or in parallel using bus bars 38. Bus bars 38 may include an electrically conductive material (copper, aluminum, etc.) arranged in any configuration (wire, strip, rod, bar, etc.). FIG. 2 illustrates six battery packs 20A, 20B, 20C, 20D, 20E, and 20F (collectively referred to as battery packs 20) electrically connected in parallel. As shown in the illustration of battery pack 20A of FIG. 2, each battery pack 20 may include a plurality of battery modules 40. Each battery module 40 may include a container that houses a plurality of battery cells (connected in series or parallel). The plurality of battery modules 40 may be connected together in series or parallel. In some embodiments, some of the battery modules 40 may be connected together in series while other battery modules 40 may be connected together in parallel. For example, the exemplary illustration of battery pack 20A shows eight battery modules 40 arranged in two columns of four battery modules 40. The four battery modules 40 in each column are connected together in series and the two columns of battery modules 40 are connected together in parallel. Each battery module 40 may include a plurality of battery cells (e.g., LTO or NMC cells) connected together in series, parallel, or a combination of series and parallel.

Although FIG. 2 illustrates the battery packs 20 as being connected together in parallel, in some embodiments, some battery packs 20 may be connected together in series to form strings of battery packs (e.g., battery packs 20A, 20C, and 20E may be connected together in series to form a first string, and battery packs 20B, 20D, and 20F may be connected together in series to form a second string). In some embodiments, battery system 14 may include a plurality of strings of battery packs 20 connected in parallel (e.g., first string and second string connected together in parallel). Configuring the battery system 14 with battery packs 20 connected in parallel may allow the bus 10 to continue operating with one or more battery packs 20 disconnected if these battery packs 20 (or the modules/cells within the battery packs) fail or experience a problem.

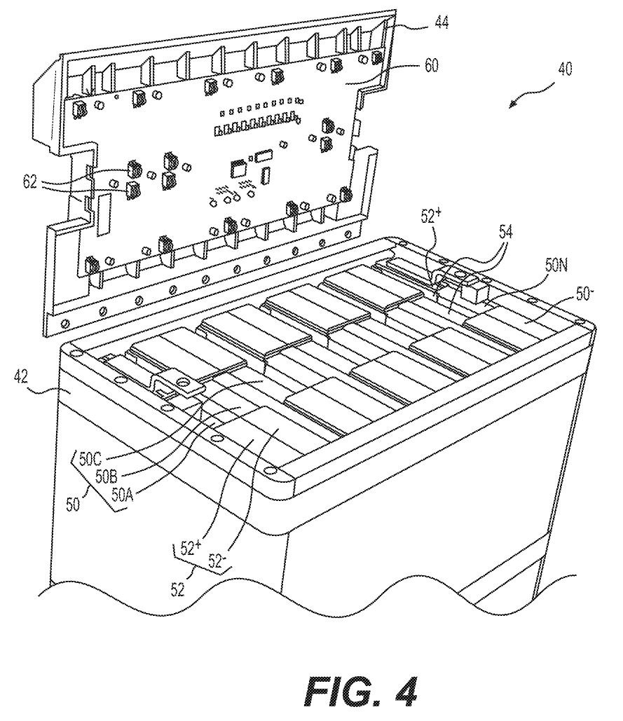

Battery system 14 may include a battery management system (BMS). Some possible embodiments of a BMS that may be used in bus 10 are described in commonly-assigned U.S. Patent Application Publication No. US 2012/0105001 A1, which is incorporated by reference in its entirety herein. The BMS may control the operations of battery system 14. The BMS may include different levels of controllers that control the operation of battery system 14 based on sensor input and/or variables programmed into these controllers. These controllers may include a module control unit (60 of FIG. 4) provided in each module 40 of the battery packs 20, a pack control unit 24 provided in each battery pack 20, and a master control unit 80 for the entire battery system 14. These control units may jointly (or singly) control the operations of the battery system 14.

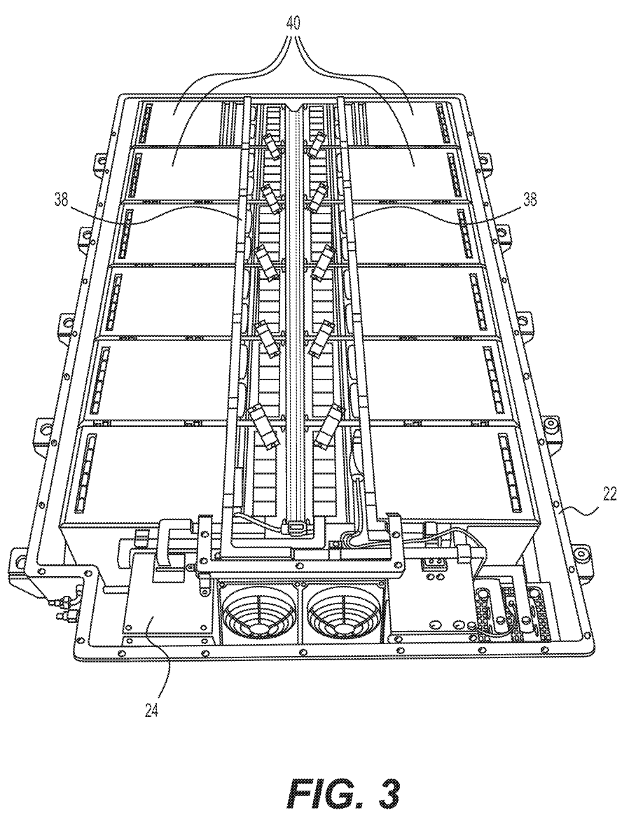

FIG. 3 illustrates an exemplary battery pack 20 of battery system 14. Battery pack 20 may have a protective housing 22 which encloses the battery modules 40 and other systems of the battery pack 20 under a lid (not shown). In FIG. 3, the lid of the housing 22 is removed to show the modules 40 positioned within the housing 22. In embodiments where the battery system 14 is positioned under the floor of bus 10, housing 22 may protect the battery modules 40 from dirt and grime on the road surface. The bus bars 38 of battery system 14 may extend into the battery pack 20 to electrically connect to the battery modules 40 of the battery pack 20. Electrical current to and from the battery modules 40 may flow through the bus bars 38. Housing 22 may also include other components such as the pack control unit 24 and sensors (current sensor, voltage sensor, temperature sensor, humidity sensor, etc.) that that measure the operating conditions of the battery pack 20. Housing 22 may also include a cooling system the cools the components of the battery packs 20 during operation of the bus 10. Further details of an exemplary battery pack 20 are described in U.S. Provisional Patent Application No. 62/155,823, filed May 1, 2015, which is incorporated by reference in its entirety herein.

Each module 40 of battery pack 20 may include multiple battery cells 50 enclosed in a container 42. FIG. 4 illustrates an exemplary module 40 of battery pack 20. In module 40 of FIG. 4, the lid 44 of container 42 is shown opened to illustrate the multiple battery cells 50 enclosed therein. In some embodiments, the lid 44 may be attached to the container 42 using one or more hinges. In some embodiments, a separate lid 44 may be used. In general, the container 42 may be made of any material (steel, toughened plastic, Kevlar, etc.). In some embodiments, the container 42 and/or its lid 44 may be made of a fire retardant or fire resistant material. Packing the battery cells 50 of a battery pack 20 (see FIG. 3) in multiple separate containers 42 may assist in isolating and decoupling battery cells that become defective (e.g., overheat, etc.) and allow the bus 10 to continue operating.

The container 42 of a module 40 may enclose any number of battery cells 50 therein. In the exemplary embodiment illustrated in FIG. 4, the container 42 encloses ten battery cells (50A, 50B, 50C, . . . 50N). These battery cells 50 may be arranged in any manner. In some embodiments, as illustrated in FIG. 4, the battery cells 50 may be vertically arranged such that the edges of each cell 50 are visible when the lid 44 is opened. In some embodiments, these cells 50 may be horizontally arranged in the container 42 such that a flat surface of a cell 50 is visible through the open lid 44. Other arrangement schemes of cells 50 are also contemplated. For example, the cells 40 may be rolled to form cylindrical elements, and the rolled cells may be horizontally or vertically arranged in container 42.

Each cell 50 may include an anode (positive tab) and a cathode (negative tab) separated by an electrolyte material. The electrolyte may be a suitable chemical medium (e.g., LTO, NMC, etc.) that allows the flow of electrical charge between the cathode and anode. When the cell 50 is connected to an electric circuit, chemical reactions occur on the anode and the cathode that create a flow of electrical energy through the cell. In each cell 50, the anode is configured as a positive tab 52⁺ and the cathode is configured as a negative tab 52⁻ (collectively referred to herein as tabs 52). A tab 52 is an electrical contact region that is used to connect the battery cell 50 to an electrical circuit (e.g., other cells, etc.). Although FIG. 4 illustrates the tabs 52 as being positioned on a top edge of each cell 50, this is only exemplary. In general, these tabs 52 may be positioned at any location on a battery cell 50.

The multiple cells 50 of module 40 of FIG. 4 are electrically connected together in series. For example, the positive tab 52⁺ of battery cell 50A is connected to the negative tab 52⁻ of the adjacent cell 50B and the positive tab 52⁺ of cell 50B is connected to the negative tab 52⁻ of the next cell 50C. All the cells of module 40 are electrically connected together in this manner and opposite polarity tabs of the end cells (i.e., tab 52⁻ of cell 50A and tab 52⁺ of cell 50N) are connected to end tabs of the adjacent modules 40 in battery pack 20. It should be noted that the above-described connection scheme is only exemplary. In general, the cells 50 of module 40 may be connected together in any manner (series, parallel, or a combination of series and parallel).

In some embodiments, the module 40 may include sensors to measure the operating conditions of the cells 50. These sensors may include thermistors (or thermocouples) to measure the temperature, humidity sensors to measure the humidity, and other sensors to measure other conditions within container 42. In some embodiments, one or more thermistors or other sensors may be embedded in a cell 50 to measure its conditions. In some embodiments, thermistors or other sensors may be positioned proximate a cell to measure its temperature and other conditions. For example, as illustrated in FIG. 4, a PCB 54 (e.g., flexible PCB) containing a thermistor (or another sensor circuit) may be positioned such that the thermistor is sandwiched between two adjacent cells 50 and its tab (i.e., measurement terminal) is positioned alongside the tabs 52 of the cells 50. In some embodiments, one or more thermistors may be positioned at selected locations of the module 40 to measure an average temperature of the cells 50.

The container 42 of module 40 may also enclose a module control unit 60 which monitors the operating parameters of the cells 50 and controls the operations of module 40. In some embodiments, as illustrated in FIG. 4, the module control unit 60 may include (or may be configured as) a printed circuit board (PCB) attached to the inside surface of lid 44. The PCB may include electrical components (e.g., integrated circuits) and/or other circuitry adapted to perform the functions of the control unit 60. These functions may include measuring the voltage (and/or other electrical parameters) of the cells 50, and the output of the sensors that measure the operating conditions (e.g., temperature, humidity, etc.) in the container. In some embodiments, the voltage of each battery cell 50 may be individually monitored by control unit 60. In some embodiments, control unit 60 may only monitor the voltage of some of the cells 50. The control unit 60 may monitor the voltage of a cell (e.g., cell 50A) by measuring the voltage across its positive and negative tabs 52⁺, 52⁻. The control unit 60 may monitor the operating conditions (e.g., temperature, humidity, etc.) of the cells 50 by measuring the voltage output by the sensors and determining the conditions that correspond to the measured voltage.

Module control unit 60 may include a plurality of electrical contact elements 62 attached thereto. When the lid 44 of container 42 is closed, some of these contact elements 62 may contact the positive and negative tabs 52⁺, 52⁻ of a cell 50 to measure the voltage across the cell. For example, a pair of contact elements 62 may press against the positive and negative tabs 52⁺, 52⁻ of cell 50A to measure the voltage across cell 50A. Other contact elements 62 attached to control unit 60 may contact the tabs of the sensors (e.g., PCB 54) in container 42 to measure its voltage output. The control unit 60 may then determine the conditions (temperature, humidity, etc.) in the module 40 corresponding to these measured voltages. When the lid 44 is opened (as shown in FIG. 4), these contact elements 62 lift off (or separate from) the corresponding tabs 52 to break the electrical connection between the tabs 52 and the control unit 60. In embodiments, where the voltage across each cell 50 is measured, a separate pair of contact elements 62 may separably contact the pair of tabs 52 of each cell 50 to measure the voltage across each cell 50.

The PCB of module control unit 60 may be attached to the lid 44 by any means. In some embodiments, nuts and bolts (not marked) may be used to attach the PCB to the inside surface of the lid 44. However, this is only exemplary. In general, any attachment mechanism (mechanical connector, adhesives, etc.) may be used to attach the PCB to the lid 44. Although the PCB of module control unit 60 is described as being attached to the inside surface of the lid 44 of container 42, this is only exemplary. In general, the module control unit 60 may be placed in the container 42 by any method. For example, in some embodiments, instead of attaching to the lid 44, the PCB of the control unit 60 may be attached to the exposed face of the battery cells 50 such that contact elements 62 in the PCB contact the corresponding tabs 52 in the battery cells 50. It is also contemplated that, in some embodiments, the PCB of control unit 60 may be freely placed on the exposed face of the battery cells 50 with the contact elements 62 contacting the corresponding tabs 52. When the lid 44 is closed, the contact elements 62 may press against the tabs 52 to improve contact. In such embodiments, the PCB and the cells 50 may include keying features that correctly locates the PCB with respect to the cells 50.

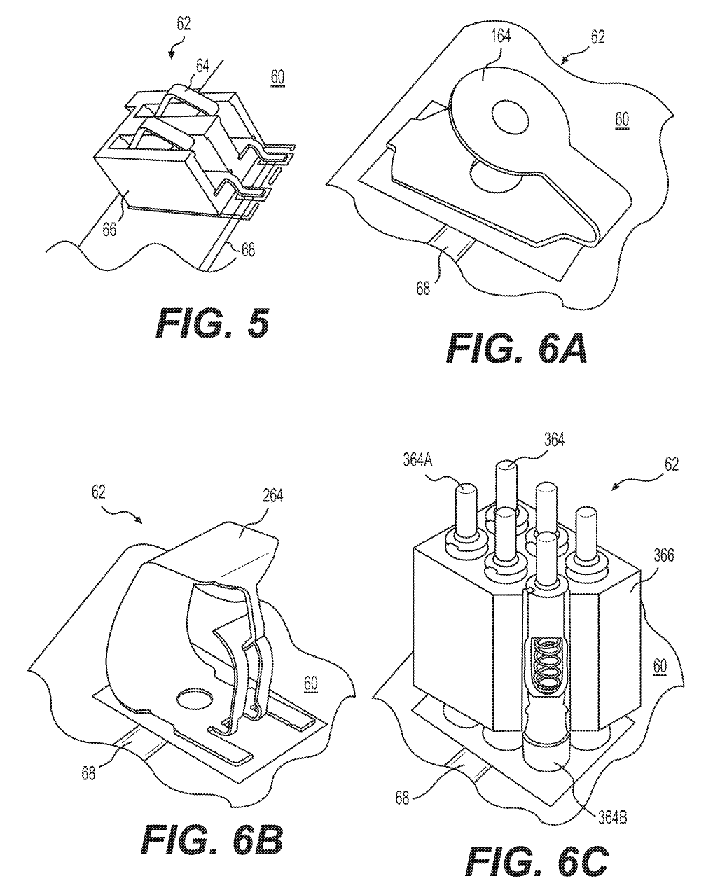

In general, any type of electrical contact structure that is adapted to separably contact a tab 52 of module 40 may be used as a contact element 62. FIG. 5 illustrates an exemplary contact element 62 that may be attached to module control unit 60. As illustrated in FIG. 5, contact element 62 may include one or more spring members 64 that deflect to apply a reaction force against, and thus press against, a tab 52 when the lid 44 is closed. By pressing against a tab 52, the contact element 62 may reduce the contact resistance and make a good electrical connection with the tab 52. The force exerted by the spring members 64 may also assist in breaking through any residue (dust, oil etc.) coatings that may be present on the tabs 52. In some embodiments, because of its shape, the spring members 64 may scrape or slide against the tab 52 as it is pressed against it. Sliding against the tab 52 may further assist improving the electrical contact between the contact element 62 and the tab 52. Although FIG. 5 illustrates a contact element 62 with two spring members 64, this is not a limitation. In general, a contact element 62 may have any number of spring members 64 and may be made of any electrically conductive material. In some embodiments, the spring member 64 may be an elastic material having a stiffness. Increasing the number of spring members 64 (and/or increasing the stiffness of the spring member 64) may increase the contact force applied to a tab 52 and thus improve electrical contact. However, excessive contact force may damage the PCB and/or the tabs 52. Therefore, the number of spring members 64 used in a contact element 62 and its shape and material may be selected based on the application.

In some embodiments, contact element 62 may also include a housing 66 to secure the spring members 64 therein. The housing 66 may be made of any material (metal, plastic, etc.) and may have features (cavities, locking features, etc.) configured to retain the spring members 64 therein. The contact element 62 may be attached to the module control unit 60 in any manner. In some embodiments, the contact elements 62 may be surface-mounted to the PCB of control unit 60. As is known to people of ordinary skill in the art, in surface-mount technology (SMT), a component (such as a contact element 62) is mounted directly to the surface of a PCB using a solder or another conductive material (conductive adhesive, etc.). When the contact element 62 is surface-mounted to the PCB of control unit 60, traces 68 in the PCB electrically connects the spring members 64 to the circuitry of control unit 60.

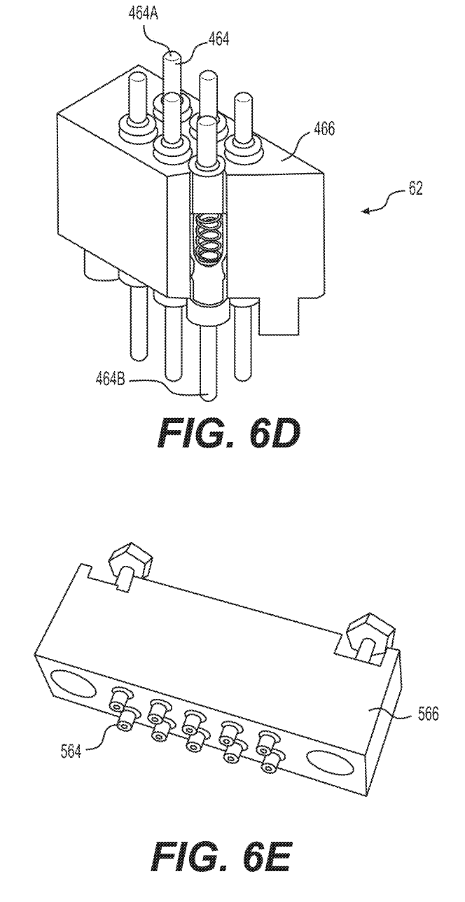

The contact element 62 illustrated in FIG. 5 is only exemplary. In general, any type of electrically conductive spring element attached to the PCB may be used as contact element 62. FIGS. 6A and 6B illustrate two other embodiments of contact elements 62 that may be attached to the PCB of module control unit 60. In the embodiments illustrated in FIGS. 6A and 6B, the housing is eliminated and spring members 164, 264 are directly surface-mounted to the PCB of control unit 60. These spring members 164, 264 are shaped to deflect (and apply reaction force to the tabs) when pressed against the tabs. In general, the spring members may have any shape and size. Although FIGS. 6A and 6B illustrate a contact element 62 made of a single spring member, this is only exemplary. In some embodiments, as discussed with reference to the embodiment of FIG. 5, the contact element 62 may have multiple spring members. In some embodiments, the spring members may be shaped to resemble a coil spring.

In some embodiments, as illustrated in FIG. 6C, a contact element 62 may include a spring loaded contact member 364 secured to a housing 366. One end (e.g., a tip 364A) of the contact member 364 may be configured to press against a tab 52 of the PCB and its opposite end 364B may be soldered to the PCB. The contact element 62 may thus be surface-mounted to the PCB of module control unit 60. The housing 366 (and/or the contact member 364) may include springs that bias the contact member 364 in the extended configuration shown in FIG. 6C. When the tip 364A of the contact member 364 is pressed against the tab 52, the contact member 364 retracts against the force of the spring to apply a reaction force on the tab 52. When the force is released (e.g., when the lid 44 of module 40 is opened), the contact member 364 returns to its extended configuration.

Although FIGS. 5 and 6A-6C illustrate contact elements 62 that are surface-mounted to the control unit 60, this is not a requirement. In general, these contact elements 62 may be attached to the control unit 60 in any manner. FIG. 6D illustrates an exemplary embodiment of a contact element 62 that may be attached to the PCB of a control unit 60 using the through-hole technology attachment method. In this embodiment, spring loaded contact members 464 are secured to a housing 466 similar to the embodiment of FIG. 6C. The ends 464B of the contact members 464 opposite the tips 464A are configured as pins that can be inserted into holes (e.g., plated through-holes or PTHs) of the PCB to retain the contact element 62 to the PCB. In some embodiments, the pins may be held in the PTHs by interference fit. In some embodiments, solders or adhesives may be used to retain the pins in the PTHs.

A contact element 62 may also be attached to the control unit 60 by other methods. FIG. 6E illustrates an embodiment of a contact element 62 that is attached to the PCB using nuts and bolts. In this embodiment, the housing 566 which houses spring loaded contact member 564 includes features (e.g., holes, slots, etc.) that may be used to attach the contact element 62 to the PCB using nuts and bolts. In this configuration, the spring loaded contact members 564 may extend from both sides of the housing 566. When the housing 566 is attached to the PCB (using the nuts and bolts), the contact members 564 on the PCB side of the housing may retract against the force of the spring and apply force against the PCB terminal. And, when the lid 44 of the module 40 is closed, the opposite ends of the contact members 564 may push against and apply force against the tabs 52.

It should be noted that the contact elements 62 illustrated in FIGS. 5-6E are only exemplary. In general, any electrically conductive compliant structure attached to the PCB (e.g., using a solder, adhesive, screws, etc.) may be used to separably contact the battery cells 50. In some embodiments, commercially available electrical contacts may be used as contact elements 62. Using contact elements 62 to seperably contact the battery cells 50 reduces the time and effort needed to make electrical connections to the battery cells and thus reduces manufacturing and servicing cost of the battery system 14. These contact elements 62 may also make detection and correction of defects in the connection easier.

While principles of the present disclosure are described herein with reference to a battery system for an electric bus, it should be understood that the disclosure is not limited thereto. Rather, the systems described herein may be employed in the batteries of any application. Also, those having ordinary skill in the art and access to the teachings provided herein will recognize additional modifications, applications, embodiments, and substitution of equivalents all fall within the scope of the embodiments described herein. Accordingly, the disclosure is not to be considered as limited by the foregoing description. For example, while certain features have been described in connection with various embodiments, it is to be understood that any feature described in conjunction with any embodiment disclosed herein may be used with any other embodiment disclosed herein.

1. A battery system for an electric vehicle, comprising:
a container having a lid;
a plurality of battery cells housed in the container, wherein each battery cell of the plurality of battery cells include a pair of tabs to electrically connect to the battery cell;
a printed circuit board attached to an inside surface of the lid of the container, wherein the printed circuit board includes circuitry adapted to monitor at least one battery cell of the plurality of battery cells; and
a pair of spring-loaded contact elements, wherein each contact element of the pair of spring-loaded contact elements is attached to the printed circuit board and biased to (a) press against, and apply a reaction force to, a tab of the pair of tabs of the at least one battery cell when the lid is closed, to electrically connect the at least one battery cell to the printed circuit board and (b) break contact with a tab of the pair of tabs of the at least one battery cell when the lid is opened.

2-3. (canceled)

4. The battery system of claim 1, further including multiple pairs of spring-loaded contact elements attached to the printed circuit board, wherein each pair of contact elements of the multiple pairs of spring-loaded contact elements is biased to press against to separably contact the pair of tabs of a separate battery cell of the plurality of battery cells.

5. The battery system of claim 1, wherein the pair of spring-loaded contact elements is attached to the printed circuit board using a solder.

6. The battery system of claim 1, wherein the pair of spring-loaded contact elements include one or more pins, and the pair of spring-loaded contact elements are attached to the printed circuit board by inserting the one or pins into plated through holes of the printed circuit board.

7. The battery system of claim 1, wherein the battery system includes a plurality of battery packs electrically connected together, each battery pack of the plurality of battery packs including multiple containers with a plurality of battery cells therein enclosed in a housing, the container being one of the multiple containers.

8. A battery system for an electric vehicle, comprising:
a plurality of battery packs electrically coupled together, wherein each battery pack of the plurality of battery packs includes a housing; and
a plurality of battery modules enclosed within the housing of each battery pack, wherein each battery module of the plurality of battery modules include:
a container with a lid enclosing a plurality of battery cells therein, wherein each battery cell of the plurality of battery cells include a pair of tabs to electrically connect to the battery cell;
a printed circuit board attached to an inside surface of the lid, wherein the printed circuit board includes circuitry adapted to monitor at least one battery cell of the plurality of battery cells; and
a pair of spring-loaded contact elements attached to the printed circuit board, wherein each contact element of the pair of spring-loaded contact elements is biased to (a) press against and make electrical contact with a tab of the pair of tabs of the at least one battery cell when the lid is closed, and (b) break electrical contact with the tab when the lid is opened.

9. The battery system of claim 8, further including multiple pairs of spring-loaded contact elements attached to the printed circuit board, wherein each pair of contact elements of the multiple pairs of spring-loaded contact elements is biased to (c) press against and make electrical contact with the pair of tabs of a separate battery cell of the plurality of battery cells when the lid is closed and (d) break electrical contact with the pair of tabs when the lid is opened.

10. The battery system of claim 8, wherein the container further includes a temperature sensor positioned therein, and wherein the printed circuit board is configured to make electrical contact with the temperature sensor when the lid is closed and break electrical contact with the temperature sensor when the lid is opened.

11. The battery system of claim 8, wherein each battery cell of the plurality of battery cells include lithium titanate oxide chemistry.

12. The battery system of claim 8, wherein each battery cell of the plurality of battery cells include nickel manganese cobalt chemistry.

13. The battery system of claim 8, wherein the pair of spring-loaded contact elements is attached to the printed circuit board using a solder.

14. The battery system of claim 8, wherein the pair of spring-loaded contact elements include one or more pins, and the pair of spring loaded contact elements are attached to the printed circuit board by inserting the one or pins into plated through holes of the printed circuit board.

15-20. (canceled)

21. The battery system of claim 1, wherein each contact element of the pair of spring-loaded contact elements deflects from an expanded configuration when the lid is open to a compressed configuration when the lid is closed to press against, and apply the reaction force to, a tab of the pair of tabs.

22. The battery system of claim 1, wherein each contact element of the pair of spring-loaded contact elements scrapes against a tab of the pair of tabs when the lid is closed.

23. The battery system of claim 1, wherein each contact element of the pair of spring-loaded contact elements includes at least two spring members.

24. The battery system of claim 8, wherein each contact element of the pair of spring-loaded contact elements deflects from an expanded configuration when the lid is open to a compressed configuration when the lid is closed to press against, and apply a reaction force to, a tab of the pair of tabs.

25. The battery system of claim 8, wherein each contact element of the pair of spring-loaded contact elements scrapes against a tab of the pair of tabs when the lid is closed.
